(19) United States
(12) Patent Application Publication
(10) Pub. No.: US 2016/0320339 A1
(43) Pub. Date: Nov. 3, 2016

(54) ELECTROCHEMICAL METHODS AND SYSTEM FOR DETECTING CADMIUM

(71) Applicant: Lantmännen Ek för, Stockholm (SE)

(72) Inventors: Fredrik Winquist, Linkoping (SE); Pär-Johan Lööf, Vange (SE)

(21) Appl. No.: 15/210,912

(22) Filed: Jul. 15, 2016

Related U.S. Application Data
(63) Continuation of application No. PCT/SE2015/050091, filed on Jan. 29, 2015.

(30) Foreign Application Priority Data
Jan. 29, 2014 (SE) 1450088-8

(51) Int. Cl. G01N 27/49; G01N 27/38; G01N 27/30

(52) U.S. Cl. CPC G01N 27/49; G01N 27/30; G01N 27/38

(57) ABSTRACT

The present invention relates to improvements of detecting cadmium in cereal samples with a voltammometric stripping method. The improvements include contacting the sample with one or several agents and adaptations of a corresponding system for fast, reliable and ambulatory measurements of cadmium in cereal samples.

This application is the continuation of international Application No. PCT/SE2015/050091, filed 29 Jan., 2015, which claims the benefit of Swedish patent application SE 1450088-8, filed 29 Jan. 2014, the entire contents of which are hereby incorporated by reference.

### FIELD OF INVENTION

The present invention is directed to a system and methods of electrochemically detecting cadmium in cereals without relying on combustion of samples.

### BACKGROUND OF THE INVENTION

Health risks from exposure of cadmium via agricultural products is a well established problem and necessitates detection of cadmium in agricultural soils. Cadmium may cause damage to the kidneys even at very low concentrations. A reliable, simple and quick method to detect cadmium in soil samples with anodic stripping voltammetry is disclosed in Precision Agriculture, 2009, Vol. 10, pp. 231-246 (F Winquist et al). One useful described system is based on a probe with three working electrodes (gold, platinum and rhodium) combined with a periodically operable electrode polishing unit by which ammonium-lactate (AL) extracted samples may be analyzed in the field down to 0.5 mg/kg by treating obtained voltammograms with multi-variate data analysis and models based on partial least squares.

A major part of the cadmium uptake originates from cereals, when it is transferred to the crop from the soil. Wheat holds a special position, since it contains higher concentrations of cadmium compared with other grains and is an important base food. Thus, there is a large need for directly accessible, quick and reliable methods for detecting cadmium in cereals at very low concentrations, down to 0.01 mg/kg, that effectively can be used in the field and to compare different cereal batches for cadmium levels. Common analytical methods for cadmium detection are complicated, expensive and time consuming, since also the samples must be burnt in a furnace to oxidize and remove all proteins that are bound to cadmium. Electrochemical methods are advantageous due to simplicity, high sensitivity and short analysis times, and can be made extremely sensitive by use of anodic stripping voltammetry. Problems using the method are the strong bonds between cereal proteins and cadmium and that interfering metal ions, present in highly variable concentrations in cereal samples may complicate the electrochemical detection. The present invention is directed to solve these problems and is directed to a system adapted to a methodology and to rapidly generate accurate analyses of cadmium in the samples.

### SUMMARY OF THE INVENTION

In one aspect, the present invention relates to a method of detecting cadmium in a cereal sample. The method most generally comprises contacting the cereal sample with at least one complexing agent, subjecting the cereal sample at least once for ultrasonic waves, at a pH below 3.0 at buffered conditions, i.e. at a defined, stable pH value, with an arrangement comprising at least one working electrode and a counter electrode, and subjecting said at least one working electrode for a negative potential with a value of from about −1.1 to about −1.5V, during a deposition time sufficient to reduce cadmium ions of the sample and admit their precipitation on said at least one working electrode surface(s) and thereafter increasing the voltage to a positive voltage, while continuously recording the current response in a voltammogram. The voltammogram may be treated with multivariate data analysis for determining concentration of cadmium in the cereal sample.

In this context, a complexing agent is a compound that binds to the outer layer of the electron layer of a metal, thus forming a metal complex, acting as a shielding layer that prevents the metal from precipitating or electrochemical influence. The complexing agent will contribute to release cadmium ions from proteins, and also complexing other interfering metal ions. A precipitating agent forms a strong bond between the metal and the precipitating agent, and forms a metal-precipitate, that will be carried away from the solution. The precipitating agent will act to precipitate interfering metal ions. Also in this context, it shall be noted that a complexing agent also can act as precipitating agent. For example, a complexing agent can act to complex metal ions at a certain pH while acting as precipitating agent at another pH.

In this aspect, contacting the cereal sample with a complexing agent has the meaning that the sample is mixed in mixing steps preferably while stirring, with a solution comprising at least one complexing agent It is also within the definition that sufficient contact by mixing between metal ions including cadmium shall be established so metal complexes are formed. In some embodiments of the inventive method, a complexing agent can also act as a buffering agent, as exemplified by citric acid. In some embodiments of the invention, a complexing agent can also act as precipitating agent, as will be illustrated with embodiments and examples below.

In a certain aspect, the method comprises the steps of adding to the cereal sample a first solution comprising the complexing agents having a pH at about 7.0, then reducing the pH in the sample from about 7.0 to a stable pH below 3.0 by adding a second buffered solution comprising an acid and a precipitating agent, while subjecting at least one of said samples having a pH value of about 7.0 and a pH value below 3.0 for ultrasonic waves. The first solution can further comprise at least two complexing agents. In one aspect, the sample is subjected to ultrasonic waves both when the sample has a pH of about 7.0 and following that the pH is reduced to below 3.0. The duration of treatment of samples with ultrasonic waves preferably varies from about 1 to 5 minutes and in one aspect, the duration is longer when the pH of the sample about 7.0. In one example, the sample is subjected to ultrasonic waves for 3 minutes when the sample has a pH of about 7.0 and for 2 minutes when the pH has been reduced to below 3.0.

In a certain aspect, the method comprises contacting the sample with one buffered solution having a stable pH below about 3.0, comprising at least two complexing agents and subjecting the sample to ultrasonic waves. According to this aspect of the method, the sample is subjected to ultrasound waves for about 2.5 to about 5 minutes.

In one aspect of the invention, at least one complexing agent comprises amine groups, as exemplified by ethylenediamine tetraacetic acid (EDTA), ethylene glycol-bis(2-aminoethylether)-N,N,N′,N′-tetraacetic acid (EGTA) and similar compounds.

In one aspect, at least two complexing agents are used with the inventive methods so at least one complexing agent comprises amine groups and at least one complexing agent is an organic acid, as exemplified by ethylenediamine tetraacetic acid (EDTA) and citric acid.

In one aspect, the precipitating agent is at least one of oxalic acid and a phosphate.

In one aspect of the inventive method, the precipitating agent may be another agent that additionally supports precipitation of specific metal ions so as to further shield off interfering metal ions during the electrochemical recording of cadmium. Such agents can be phosphates or a specific supplemental agent selected to remove a selected ion determined from interfering with the detection. For example, if the cereal sample is determined or considered to comprise high levels of copper ions from a copper-rich soil, a copper-binding such agent can be included. One example of such an agent is penicillamine. In one example the precipitating agent is at least one of oxalic acid and tartaric acid together with a supplementary agent such as a phosphate or an ion-specific agent such as pencillamine.

According to the aspect of the inventive method, a first solution of pH 7.0 is added to the cereal sample and then a second solution with low pH is added to reduce pH to lower than 3.0, the first solution comprises EDTA and citric acid as complexing agents and the second solution comprises oxalic acid as a precipitating and buffering agent and a strong acid, such a nitrous acid,.

According to the aspect the cereal sample is contacted with one solution having pH below 3.0, the solution may comprise EDTA and, citric acid as complexing agents, and optionally oxalic acid or phosphate as a precipitating and/or buffering agent.

In the mentioned aspect, when contacting the sample with a first solution comprising EDTA and citric acid and the second solution comprising oxalic acid, the first solution can comprise from about 10 to about 20 mg/l of EDTA and from about 0.3 to about 0.7 g/l of citric acid and the second solution can comprise from about 0.05 to about 0.2 g/l of oxalic acid buffered to pH below 3.0, such as a pH value of about 2.0, 2.4 or 2.7 with HNO₃.

In the mentioned aspect when contacting the sample directly with a solution having pH less than about 3.0 such as pH of about 2.0, 2.4 or 2.7, the solution can comprise of two complexing agents. In one embodiment the solution comprises at least EDTA and citric acid as complexing agents. The solution can further comprise a precipitating agent, such as oxalic acid. The solution can also comprise phosphates as additionally precipitating agents together or without an organic acid, such as oxalic acid. Optionally, a copper-binding agent, such as penicillamine can be included. These solutions can be adjusted to the suitably low pH by HNO₃, or by being buffered by citric acid, phosphate and oxalic acid system if strong acids are to be avoided. In one example, the solution comprises 10 to 20 mg/l of EDTA and about 0.3 to about 0.7 g/l of citric acid and a precipitating agent, preferably from about 0.05 to about 0.2 g/l of oxalic acid. In another example the solution comprises 10 to 20 mg/l of EDTA and about 3 to about 7 g/l of citric acid, while pH is adjusted to about 3.0.

The discussed solutions can further comprise additional agents such agents that support or stabilize the electrochemical measurements (such as KNO3) or stabilize the solutions characteristics in general.

In one aspect of the invention, the methods comprise polishing of the surface of the at least one working electrode and the counter electrode before contacting the cereal sample. The polishing comprises contacting such a working electrode with a rotatable polishing bar. The rotating polishing can be admitted to rotate at a predetermined distance from the surface of said at least one working electrode, while agitating the sample. The polishing step can optionally be followed by a conventional electrochemical regeneration step. The polishing step can further advantageous include altering the electrode potential from a negative value to a positive value. In order to remove cadmium interfering metals, a suitable alteration of potential from −1.5 V to +1.5 V is applied to the working electrode.

The deposition time, during which the at least one working electrode is subjected to a negative potential with a value of from about −1.1 to about −1.5V, sufficient to reduce (essentially all) metal (cadmium) ions of the sample, varies according to the invention from about 30 seconds to about 5 minutes. Examples of suitable deposit times are 120 and 180 seconds. During this deposition step, the sample mixture must be vigorously stirred to enhance exchange of sample mixture with the working electrodes.

In one aspect of the inventive methods voltammograms are recorded for different deposit times, and the difference between the so recorded voltammograms are recorded and determining the cadmium the concentration of cadmium is determined from a resulting voltammogram.

In one aspect of the inventive methods, the negative potential with a value of from about −1.1 to about −1.5V, and then increasing the voltage to a value of about +0.6 V for a predetermined time period (stripping time). The time period suitably is less than about 500 milliseconds, such as 50-500 milliseconds. The voltage is increased stepwise in predetermined steps, or alternatively the voltage is increased continuously.

In a different aspect, the invention relates to a system adapted to determine the concentration of cadmium in cereal samples by performing any of the previously outlined methods.

In one aspect, the system comprises at least two working electrodes for contacting a cereal sample, both accommodated in a metal tube serving as a counter electrode; a control unit adapted to operate a potentiostat connected to the working electrodes. Preferably, at least one working electrode is made of gold and one working electrode is made of rhodium. Preferably, the system comprises two or three working electrodes of gold and one rhodium working electrode.

In one aspect the system comprises an electric motor operably connected to a polishing unit for polishing the working electrode surfaces and the counter electrode (also serving as a reference electrode).

In a further aspect, the system further comprises a device adapted to receive at least one voltammogram from the working electrodes and calculating a cadmium concentration value, wherein the device comprises a calculating unit capable of predicting the cadmium concentration, by employing a prediction function generated from multivariate data analysis methods selected from at least one of PLS (projection to latent structure) or ANN (artificial neural net) based on previous measurements of cadmium concentration.

The so described methods and systems can accurately perform cadmium determinations in cereals within 10 minutes, suitably within 5 minutes for cadmium concentration ranging from 0.01 to 1.0 mg/kg.

### BRIEF DESCRIPTION OF THE DRAWINGS

FIG. 1 is a schematic illustration of the voltammetric probe of the present invention.

FIG. 2 shows a typical voltammogram, demonstrating a reference measurement followed by a differential measurement.

FIG. 3 shows voltammograms from five samples with cadmium concentration ranging from 0.02 to 0.15 mg/kg.

FIG. 4 is an enlargement of the cadmium peak area in FIG. 3.

FIG. 5 shows cross-validated data from a measurement series of 11 original (squares) and 7 spiked (circles) shown for predicted versus true values.

FIG. 6 shows voltammograms for samples treated in accordance with a particular embodiment of the invention.

### DETAILED DESCRIPTION

A stock standard of 10 mM cadmium was prepared by dissolving 0.182 g of CdCl₂ (Merck, Germany) in 100 ml of 0.1 M HNO₃. Standards of cadmium were then prepared by appropriate dilution.

Ultrapure water (Millipore) was used throughout the measurements.

Ethylenediamine tetra acetic acid (EDTA) and citric acid were obtained by Merck, Germany. All samples and standard were kept in polyethylene vessels.

Wheat flour samples were obtained from SW Seed, Sweden. Thus, whole wheat grain were milled and analyzed for content of cadmium. 11 samples were analyzed, with cadmium content ranging from 0.01 to 0.25 mg/kg.

The Voltammetric Probe

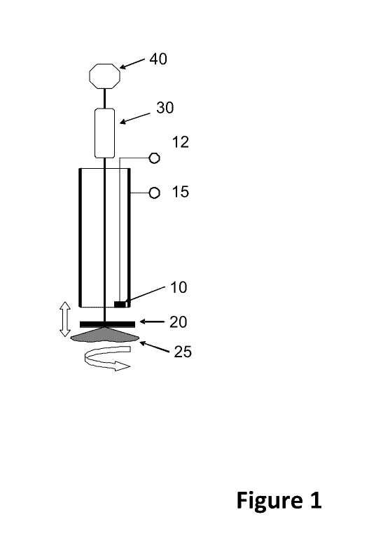

The electrochemical probe consisted of a stainless tube (outer diameter 10 mm, inner diameter 8 mm), the edge also serving as a counter/reference electrode. An electrode of gold (diameter 1 mm) was embedded in a dental material (3M Company, U.S.A.) in one edge on the tube. Through the centre of the tube, an inner rod (diameter 1 mm) was placed, equipped with a polishing bar and a propeller for mixing the sample solution. The rod can be both rotated and moved up and down. At the other end of the rod, it is connected to an electric motor and a pressure relay. FIG. 1 schematically shows the electrode set up. The outer stainless steel tube serves as a counter electrode, connected at point 15, to the gold electrode 10, connected at point 12. The equipment comprises a polishing unit with a polishing bar 20 for the gold electrode driven by the motor 30 and connected to the pressure relay 40. The motor 30 also drives the propeller 25 for stirring the solution.

During stirring, the polishing unit is rotated at a speed of 5 rps, with the polishing bar placed 0.5 mm from the gold electrode. At certain time intervals, the pressure relay presses the polishing bar against the gold electrode, thus polishing both the working electrodes and the counter electrode.

The measurement probe was connected to a potentiostat, operated by a computer. The computer also was used for storing data and to operate the electric motor and the pressure relay.

Data Analysis

Voltammetric measurements consist of a number of variables and are often difficult to interpret. Multi-variate methods, like principal component analysis (PCA) and partial least squares (PLS), have been shown to be very useful to interpret data. PCA describes the variance in experimental data. A score plot can be made, showing the correlations between the samples which can be used for classification. PLS is used to make models from calibration sets of data, which then is used to predict values from the voltammograms. It is a linear method, in which PCA is performed on both the voltammogram and the corresponding concentrations, giving a regression model

In PLS modelling, the prediction error is given by RMSEP (Root Mean Square Error of Prediction). One useful way of evaluating the prediction capacity of the model is to use the RPV (Relative Predicted Deviation) value. This is defined as the standard deviation of the whole dataset divided by the standard error of prediction. For a useful model, this value should be 2 or above.

Principal component analysis (PCA) and modelling using partial least square (PLS) were performed using the software SIRIUS 6.5 (Pattern Recognition Software, PRS; Bergen, Norway).

Artificial neural nets (ANN's) can also be used for predictions. They consist of an input layer, one or more hidden layers and an output layer. The layers are connected with each other with logarithmic transfer functions, and by training, the method of backpropagation of errors is often used. When dealing with non-linear data, ANN's often give better predictions compared with linear methods such as PLS. Since ANN's are vulnerable to larger amount of input variables, the most important variables given from correlation coefficients in the PLS modelling can be chosen. The software Brainmaker (California Scientific Software, U.S.A.) was used for ANN analysis

### EXAMPLE 1

Measurement Procedure

10 g of wheat flour was added to 40 ml pure water in a polyethylene beaker, also containing the voltammetric probe. EDTA was added, and after 2 minutes of stirring, HNO₃, citric, oxalic and tartaric acid were added, giving a final pH of 2.7. The measurement sequence started by a polishing step during 30 s, thereafter an electrochemical rinsing with 50 alternating pulses of +0.5 V and −1.3V, each 2 msec long. Thereafter the reference measurement started by applying a voltage of −1.3 V during 10 sec, followed by increasing the voltage by steps of 0.005 V during 0.002 sec, until a final voltage of 0.5 is reached. During this stripping stage, the stirring was turned off, in order to ensure stable measurement. After the reference measurement, exactly the same procedure was repeated, except that the deposition time was changed from 10 sec to 180 sec. The measurement sequence was controlled by the computer, which also collected data from the potentiostat, and the mathematical calculations, using a simple Pascal program.

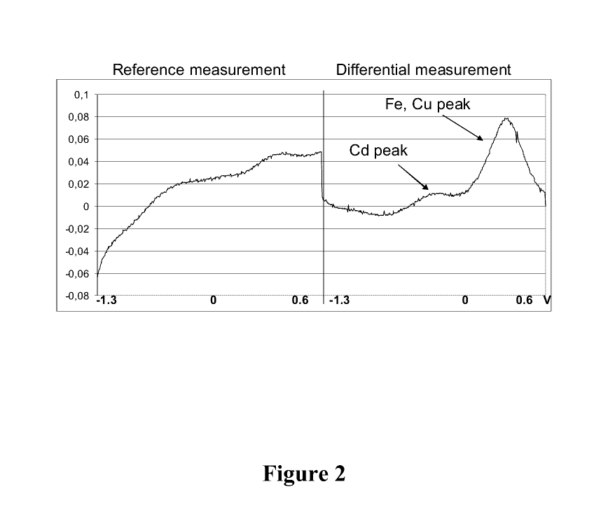

Altogether 11 samples of wheat flour with known concentration of cadmium ranging from 0.011 to 0.172 mg/kg were obtained from SW Seed, Sweden, and 7 of these were additionally spiked with 0.05 or 0.01 mg cadmium/kg, giving altogether 18 samples to investigate. A typical voltammogram from a sample containing 0.09 mg cadmium/kg is shown in FIG. 2. The first part of the voltammogram entails the reference measurement, the last part the differential measurement. Two oxidation peaks are clearly shown in the latter, the first originating from cadmium, and the second from iron and copper. In the reference part, this second peak can also be discerned.

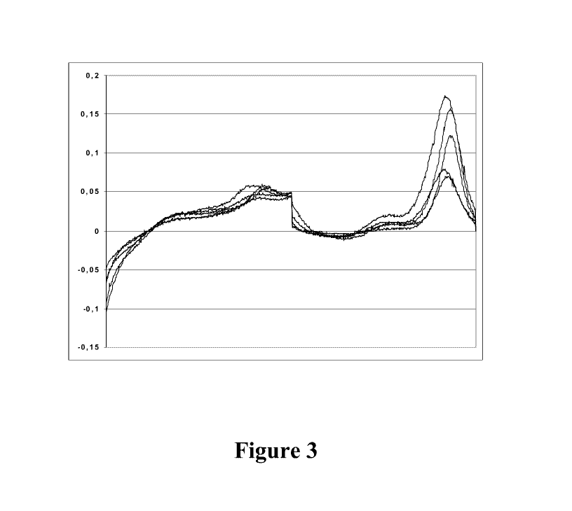

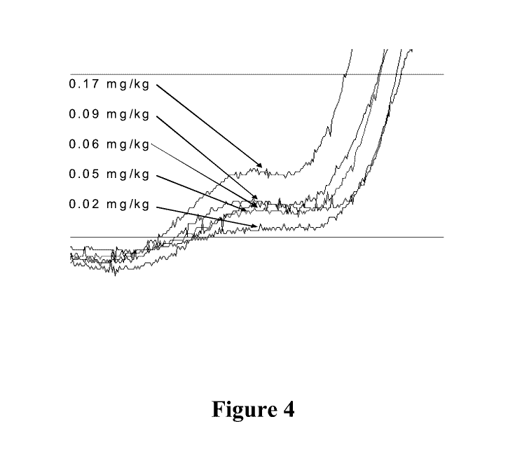

In FIG. 3, voltammograms from five samples are shown with cadmium concentration ranging from 0.02 to 0.17 mg/kg. The cadmium peaks are clearly shown for all samples, and an enlargement of this area is shown in FIG. 4. It can clearly be seen that the peak height are well correlated with the corresponding cadmium concentration.

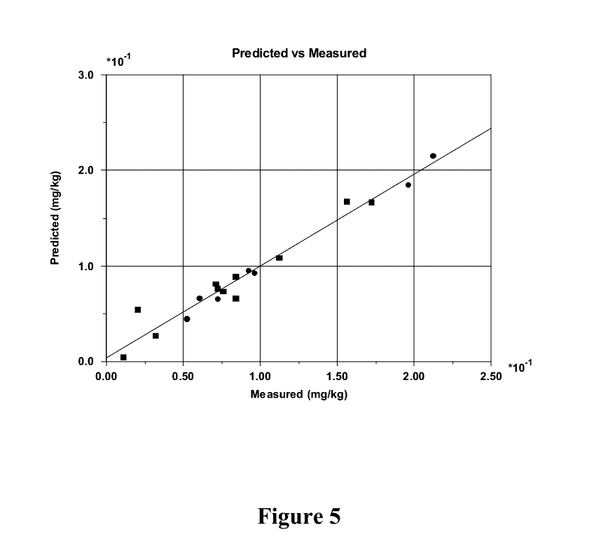

Data from the voltammograms from all 18 samples were also treated with PLS modelling according to the data analysis, as earlier described. Cross-validated data from this measurement series are shown for predicted versus true values is shown in FIG. 5. Spiked samples are indicated as squares. The RMSEP was 0.019 mg/kg and the RPD was 3.56, indicating that cadmium in this concentration region could be very well predicted.

In Table 1, the spiked samples are shown with corresponding predicted values (mg/kg).

TABLE 1
Table 1 Spiked samples and corresponding predicted values (mg/kg).

| Sample | Added | Spiked sample | Predicted | Error % |
|---|---|---|---|---|
| 0.076 | 0.020 | 0.096 | 0.100 | 104 |
| 0.172 | 0.040 | 0.212 | 0.210 | 99 |
| 0.020 | 0.040 | 0.060 | 0.054 | 90 |
| 0.072 | 0.020 | 0.092 | 0.089 | 97 |
| 0.156 | 0.040 | 0.196 | 0.208 | 106 |
| 0.032 | 0.020 | 0.052 | 0.059 | 113 |
| 0.032 | 0.040 | 0.072 | 0.080 | 111 |

As can be seen, cadmium in this concentration region could be well predicted for the spiked samples.

### EXAMPLE 2

Two different measurement procedures of the invention are outlined in Example 2, one for more accurate results used in analytical laboratories, the other for shorter analysis times at collecting stations for cereals.

Buffer EA1

10 g KNO₃

5 g Citric acid

14 mg Ethylenediamine tetraacetic acid (EDTA)

1 l distilled water

Adjust pH to 3.0 by adding a solution with KOH.

Buffer EA2

10 g KNO₃

14 mg Ethylenediamine tetraacetic acid (EDTA)

0.5 g citric acid

1 liter distilled water

Buffer EA3

1 ml concentrated HNO₃

0.5 liter distilled water.

0.1 g oxalic acid

0.5 liter distilled water

For Accurate Results

Procedure

Add 10-15 g of wheat flour in a polyethylene beaker and add 40 ml EA2

Place the beaker in an ultra sonic bath.

Stir vigorously and run the ultrasound for 3 minutes

Add 15 ml EA3

Run the ultrasound for 2 minutes

Insert the voltammetric sensor.

Run the stripping programme, with deposition time 180 sec at −1.2 V, and scanning from −1.2-0.5 V during 70 ms.

Collect data and predict the cadmium concentration by using trained prediction models (based on e.g. PLS or ANN)

For Fast Results

Procedure

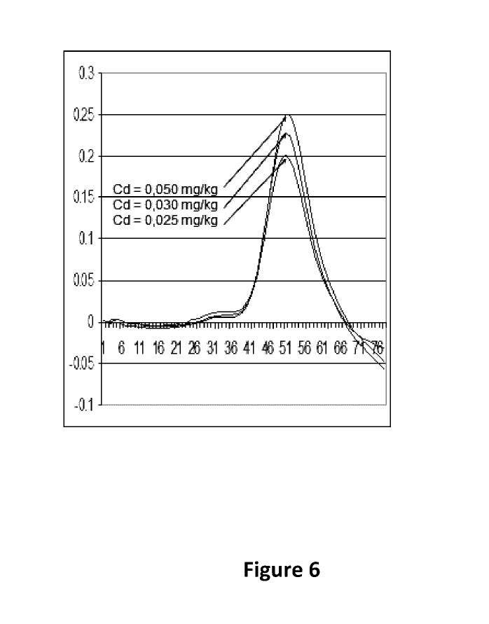

10 g of wheat flour was added to 40 ml of the EA1 buffer in a plastic beaker with magnetic stirring and the voltammetric probe. The measurement sequence started by a polishing step during 20 s, thereafter an electrochemical rinsing with 50 alternating pulses of +0.5 V and −1.2V, each 2 msec long. Thereafter the reference measurement started by applying a voltage of −1.2 V during 20 sec, followed by increasing the voltage by steps of 0.01 V during 0.001 sec, until a final voltage of 0.5 is reached, taking altogether 0.170 ms. During this stripping stage, the stirring was turned off, in order to ensure stable measurement. After the reference measurement, exactly the same procedure was repeated, except that the deposition time was changed from 10 sec to 180 sec. The reference sequence was subtracted from the measurement sequence. The measurements were controlled by a computer, which also collected data from the potentiostat, and carried out the mathematical calculations, using a simple Pascal program. The results are shown in FIG. 6.

1. A method of detecting cadmium in a cereal sample, comprising:
(i) contacting the cereal sample with at least one complexing agent.
(ii) subjecting the cereal sample at least once to ultrasonic waves.
(iii) contacting the sample at a stabilized pH below 3.0 at buffered conditions with an arrangement comprising at least one working electrode and a counter electrode, and subjecting said at least one working electrode for a negative potential with a value of from about −1.1 to about −1.5V during a deposition time sufficient to reduce cadmium ions of the sample and admit their precipitation on said at least one working electrode surface(s); and
(iv) increasing the voltage to a positive voltage, while continuously recording the current response in a voltammogram and determining concentration of cadmium in the cereal sample.

2. The method according to claim 1, comprising the steps of:
a) adding to the cereal sample a first solution comprising at least two complexing agents having a pH at about 7.0;
b) reducing the pH in the sample from about 7.0 to a stable pH below 3.0 by adding a second buffered solution comprising an acid and at least one precipitating agent;
c) subjecting at least one of said samples having a pH value of about 7.0 and a pH value below 3.0 to ultrasonic waves.

3. The method according to claim 1, comprising providing the sample with a buffered solution having a stable pH below about 3.0, comprising at least one complexing agent. and subjecting the sample to ultrasonic waves.

4. The method according to claim 3, further comprising a precipitating agent.

5. The method according to claims 1, wherein at least one complexing agent comprises amino groups.

6. The method according to claim 5, comprising at least two complexing agents of which at least one is an organic acid.

7. The method according claim 1, wherein the complexing agents are ethylenediamine tetraacetic acid (EDTA) and citric acid.

8. The method according to claim 2, wherein the precipitating agent is at least one of oxalic acid and phosphate.

9. The method according to claim 2, wherein the first solution comprises EDTA and citric acid as complexing agents and the second solution comprises oxalic acid or phosphate as a precipitating agent.

10. The method according to claim 4, wherein the solution comprises EDTA and citric acid as complexing agents, and wherein the precipitating agent comprises oxalic acid or phosphate.

11. The method according to claim 1, comprising polishing the surface of the at least one working electrode and the counter electrode before contacting the cereal sample.

12. The method according to claim 1, wherein in the deposition time sufficient to reduce essentially all cadmium ions of the sample varies between 30 seconds and 5 minutes.

13. The method according to claim 1, comprising recording voltammograms for different deposit times, determining the difference between the so recorded voltammograms and determining the cadmium concentration from a resulting voltammogram.

14. The method according to claim 1, wherein the time to change the negative potential with a value of from about −1.1 to about −1.5V, to a value of about +0.6 V not exceeds about 100 milliseconds.

15. A system adapted to determine the concentration of cadmium in cereal samples according to the method of claim 1, comprising:
at least one working electrode for contacting a cereal sample, both accommodated in a metal tube serving as a counter electrode,
a control unit adapted to operate a potentiostat connected to the working electrodes,
an electric motor operably connected to a polishing unit for polishing the surfaces of the working electrode and the counter electrode, wherein
two or more working electrodes are made of gold and at least one working electrode is made of rhodium.
